(19) United States
(12) Patent Application Publication
(10) Pub. No.: US 2015/0242495 A1
(43) Pub. Date: Aug. 27, 2015

(54) SEARCH MACHINE FOR PRESENTING ACTIVE SEARCH RESULTS

(71) Applicant: Hipmunk, Inc., San Francisco, CA (US)

(72) Inventors: Adam Julian Goldstein, San Francisco, CA (US); Steven Ladd Huffman, San Francisco, CA (US); Nancy Tu Hang, San Francisco, CA (US)

(21) Appl. No.: 14/613,864

(22) Filed: Feb. 4, 2015

Related U.S. Application Data
(60) Provisional application No. 61/943,762, filed on Feb. 24, 2014.

(51) Int. Cl. G06F 17/30

(52) U.S. Cl. CPC G06F 17/30648; G06F 17/30864; G06F 17/3053

(57) ABSTRACT

A search machine may store a page state of a results page that includes search results, as well as one or more selections, filter parameters, sort parameters, or comments applied by the user to one or more active search results. Prior to storing the page state, the search machine may determine that only active search results are to be stored, and determine which search results are the active search results. The user may access the search machine from a second device, and the search machine may cause the second device to present some or all of the same search results with one or more selections, filter parameters, sort parameters, or comments applied. Thus, when the same search results are presented by the second device, the same contents, same selections, and same layout may be preserved and match what the user previously viewed using the first device.

### TECHNICAL FIELD

This application claims the priority benefit of U.S. Provisional Application No. 61/943,762, filed Feb. 24, 2014, which is incorporated herein by reference in its entirety.

### TECHNICAL FIELD

The subject matter disclosed herein generally relates to the processing of data. Specifically, the present disclosure addresses systems and methods to facilitate presenting active results (e.g., active search results).

### BACKGROUND

A user may operate a machine (e.g., a device) to execute a search of one or more databases and obtain corresponding search results from the executed search. For example, a device of the user may execute an application that configures the device to submit a set of one or more search criteria to a search engine (e.g., a search machine). For example, the application may be a multi-purpose application (e.g., a web browser operable to interact with any of various web pages) or a single-purpose application (e.g., a dedicated mobile app or applet operable to interact with a single web site). The search engine may be or include a group of one or more server machines configured to provide one or more search engine services. As configured by the application, the device may accordingly request and receive, from the search engine, a set of one or more search results based on (e.g., in response to) the submitted set of search criteria. The application may then cause the device to present some or all of the received search results within a page (e.g., a web page or a screen page within a user interface of the application). This page may be displayed by the device (e.g., on a screen that is built into the device or externally connected to the device).

### BRIEF DESCRIPTION OF THE DRAWINGS

Some embodiments are illustrated by way of example and not limitation in the figures of the accompanying drawings.

FIG. 1 is a network diagram illustrating a network environment suitable for presenting active search results, according to some example embodiments.

FIG. 2 is a block diagram illustrating components of a search machine suitable for presenting active search results, according to some example embodiments.

FIG. 3 is a block diagram illustrating components of a first device suitable for presenting search results, according to some example embodiments.

FIG. 4 is a block diagram illustrating components of a second device suitable for presenting active search results, according to some example embodiments.

FIG. 5 is a diagram of a results page showing results within a first tab, according to some example embodiments.

FIG. 6 is a diagram of the results page showing additional results within a second tab, according to some example embodiments.

FIG. 7 is a flowchart illustrating data flows within the network environment, according to some example embodiments.

FIGS. 8 and 9 are flowcharts illustrating operations of the search machine in performing a method of presenting active search results, according to some example embodiments.

FIG. 10 is a block diagram illustrating components of a machine, according to some example embodiments, able to read instructions from a machine-readable medium and perform any one or more of the methodologies discussed herein.

### DETAILED DESCRIPTION

Example methods and systems are directed to a search machine configured to present active search results. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A search machine (e.g., a search engine server machine) is configured (e.g., by suitable modules) to provide one or more search services to one or more devices. As configured, the search machine enables a user to execute a search from a first device (e.g., a mobile smart phone), and the search machine provides corresponding search results to that first device, for example, within a results page (e.g., a search results page, in the form of a webpage of a website or an app screen of a mobile app, that presents some or all of the search results) that may be interactive and thus may enable the user to apply one or more selections, filters, sorts, comments, or any suitable combination thereof.

The search machine is also configured to generate and store a page state of the results page, including one or more search results (e.g., search results determined to be active search results), as well as one or more selections (e.g., selection indicators or save indicators), filter parameters (e.g., filter criteria), sort parameters (e.g., ranking parameters), or comments (e.g., likes, favorites, sharing with friends) applied by the user to the active search results. In storing the page state, the search machine determines that only active search results are to be stored, and determines which search results are actually active search results. One or more search results may be excluded from the active search results if they are determined to be closed (e.g., presented in a tab or page that is later explicitly closed by the user), cleared (e.g., presented in a tab or page in which the user later clears, deletes, or modifies the corresponding search criteria), current (e.g., still being presented to the user on the first device, or some other device), expired (e.g., older than a threshold age or obsoleted by newer or updated search results), or any suitable combination thereof. One or more search results may be included in the active search results if the user has indicated that they are to be saved (e.g., bookmarked as a favorite, indicated as being liked, added to a wish list, or shared with another user by email or other message).

Thereafter, the user can access the search machine from a second device (e.g., a tablet or personal computer (PC)), and the search machine is configured to cause the second device to present some or all of the same search results (e.g., some or all of the search results determined to be active search results) with one or more selections, filter parameters, sort parameters, or comments applied. Furthermore, in providing such search results to the second device, the search machine may update one or more of the search results (e.g., by accessing updated details for those search results).

In some example embodiments, various search results (e.g., from multiple queries submitted) are displayed together in the same results page (e.g., in a single tab within a single page). In alternative example embodiments, the results page includes multiple tabs (e.g., displayable one at a time within the borders of the results page), and each tab may show active search results from a different search. In other example embodiments, the results page may include multiple buttons (e.g., selectable one at a time), and each button may cause the results page to show the corresponding results for a different search. For example, the search machine may provide separate travel search services for flights, hotels, and events, and the results page may show available airline flights on a first tab (e.g., flights tab) of search results, available hotel reservations on second tab (e.g., hotels tab) of search results, and available event reservations on a third tab (e.g., events tab) of search results. As another example, the results page may show available airline flights in response to a first button (e.g., flights button) being selected, available hotel reservations in response to a second button (e.g., hotels button) being selected, and available event reservations responsive to a third button (e.g., events button) being selected. In further example embodiments, a combination (e.g., a first combination) of search results of multiple different types (e.g., available flights, hotels, and events) are shown on a first tab or in response to selection of a first button, and a different combination (e.g., second combination) of search results of multiple different types are shown on a second tab or in response to selection of the second button. Although these example scenarios, for sake of clarity, focus on searches for flights, hotels, and events (e.g., restaurant reservations, theater tickets, and concert tickets), additional types of searches (e.g., car rentals, cruises, vacation packages, and spa services) may be implemented similar manner.

In storing the page state of the results page, the search machine may store the contents of the tabs (e.g., results grouped by the tab in which they appear), indicators of any selections made by the user, the layout (e.g., arrangement) of some or all tabs within the results page, or any suitable combination thereof. Thus, when the same search results are presented by the second device, the same contents, same selections, and same layout can be preserved (e.g., to match what the user previously viewed using the first device). Although the present discussion, for sake of clarity, describes tabs within the results page, other user interface elements (e.g., windows, popups, drawers, sidebars, or buttons) may be configured to provide similar functionality and exhibit similar behavior.

As an illustrative example from a user perspective, suppose a user named Bob launches a mobile app on his smartphone, and the mobile app allows Bob to access the search machine (e.g., operating a search engine at Hipmunk.com®) and perform a flight search for airline flights from San Francisco to New York City, as well as perform a hotel search for three nights in New York City. The search machine may identify Bob as a known user (e.g., from Bob's login credentials, a persistent cookie, a network address of Bob's smartphone, a hardware identifier of his smartphone, or his submitted search criteria) and provide search results in response to his two queries. The search results are displayed in a results page by the mobile app on Bob's smartphone. For instance, the flight search results may be displayed in a flight tab within the results page, while the hotel search results may be displayed in a hotel tab within the same results page. After viewing the search results, Bob may select a particular flight (e.g., a 7 AM departure from San Francisco on United Airlines) and a particular hotel (e.g., the New York Hilton Midtown). As displayed on Bob's smartphone, the mobile app indicates (e.g., visually) that this particular flight and this particular hotel have been selected (e.g., with highlights, markers, or other suitable indicators) from among the search results.

However, Bob turns off his smartphone before taking any further action (e.g., due to some interruption). Fortunately, the page state of the mobile app has been stored (e.g., within a database) by the search machine for later use (e.g., by repeatedly storing updated versions of the page state while Bob's smartphone was running the mobile app). In particular, the search machine may determine which search results are not closed, cleared, or expired, and save these search results as “active” search results. In this illustrative example, “closed” search results are those that were presented in a tab or page that is expressly closed by Bob. “Cleared” search results are those that were presented in a tab or page with corresponding search criteria that Bob later replaces with different search criteria. “Expired” search results are those that indicate a travel date in the past or scheduled to occur within an unreasonably short time (e.g., a flight that departs in 30 minutes from airport over 30 minutes away, or a hotel reservation located over two hours away by airplane or by car, with a check-in deadline in two hours from a present time). Moreover, the search machine may limit the active search results to those derived from a threshold number (e.g., predetermined threshold number or reference number) of most recent active searches (e.g., the previous ten searches that produced one or more active search results, according to one or more of the above criteria for active search results).

Sometime later, Bob is sitting at his desktop computer at work and launches a web browser to access the search machine (e.g., Hipmunk.com®) again, but this time from his desktop computer instead of his smartphone. The search machine again identifies Bob (e.g., from login credentials, a persistent cookie, a network address of Bob's computer, a hardware identifier of his computer, or his submitted search parameters). Based on the fact that the page state of the mobile app is available (e.g., a most recently updated version of the page state, as stored by the search machine in the database), the search machine promptly generates (e.g., regenerates) the results page, which has tabs already showing the search results from Bob's previous flight search and his previous hotel search. The search machine then provides this results page to Bob's desktop computer for display. Moreover, the results page has automatically selected (e.g., visually) the particular flight (e.g., the 7 AM departure from San Francisco on United Airlines) and the particular hotel (e.g., the New York Hilton Midtown) and indicated these selections (e.g., with the same highlights, markers, or other suitable indicators).

Furthermore, one or more of the search results in the results page may be updated by the search machine (e.g., by accessing updated details, such as price and availability). In addition, one or more of the search results in the results page may be replaced by the search machine (e.g., by re-executing the search). For example, if the particular flight is no longer available, the search machine may rerun the flight search and automatically find and select a different flight that is determined by the search machine to be most similar to the particular flight that is now unavailable.

Also, the search machine may generate (e.g., regenerate) the results page to contain suggested or recommended search results (e.g., by executing, accessing, or otherwise utilizing a recommendation engine). Accordingly, the results page may also contain one or more similar flights or hotels that are available, are cheaper, are liked by similar users, are located nearby, have similar ratings, have similar amenities, have special rates or availability specifically for Bob's demographic group, or any suitable combination thereof. Any one or more of these recommended results may be automatically selected in the results page provided to Bob's desktop computer (e.g., in lieu of a previously selected but now unavailable search result, or in lieu of a previously selected result that is still available but determined by the search machine to be less desirable to the user than the automatically recommended results).

Thus, Bob can view one or more of his previous search results (e.g., with or without updates) alongside one or more additional recommendations in the same visual context as before (e.g., with the same layout of tabs, sorted in the same sort order according to the same sort parameters, filtered by the same filter parameters, or any suitable combination thereof), which may significantly assist with Bob's decision-making (e.g., visual recognition of one or more available search results). Viewing such a results page, Bob may spend less time and effort in discovering that a particular flight or hotel is no longer available, reviewing his previous search results, comparing them with new suggestions or recommendations, or any suitable combination thereof.

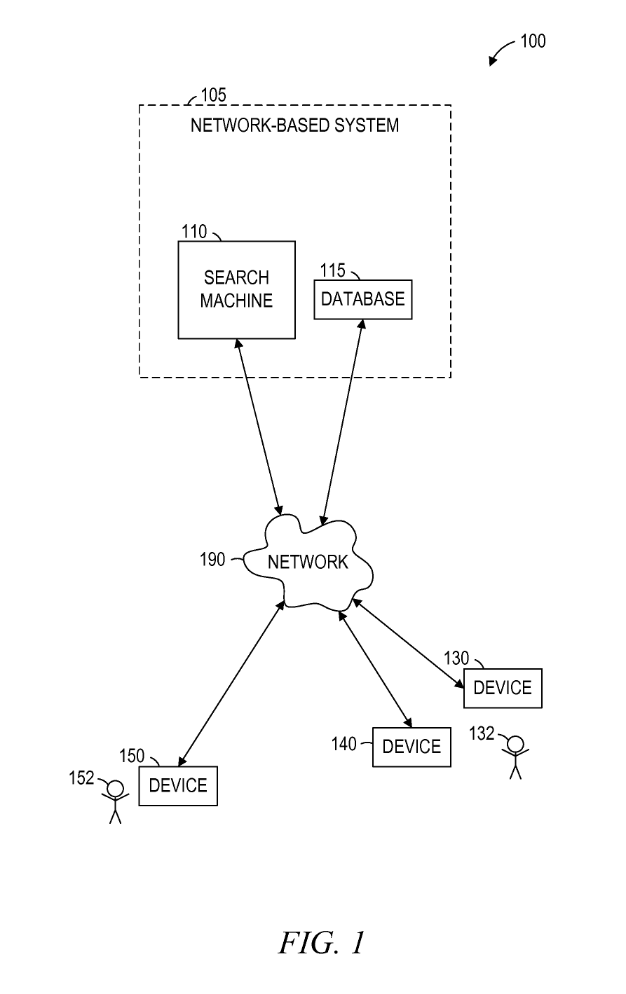

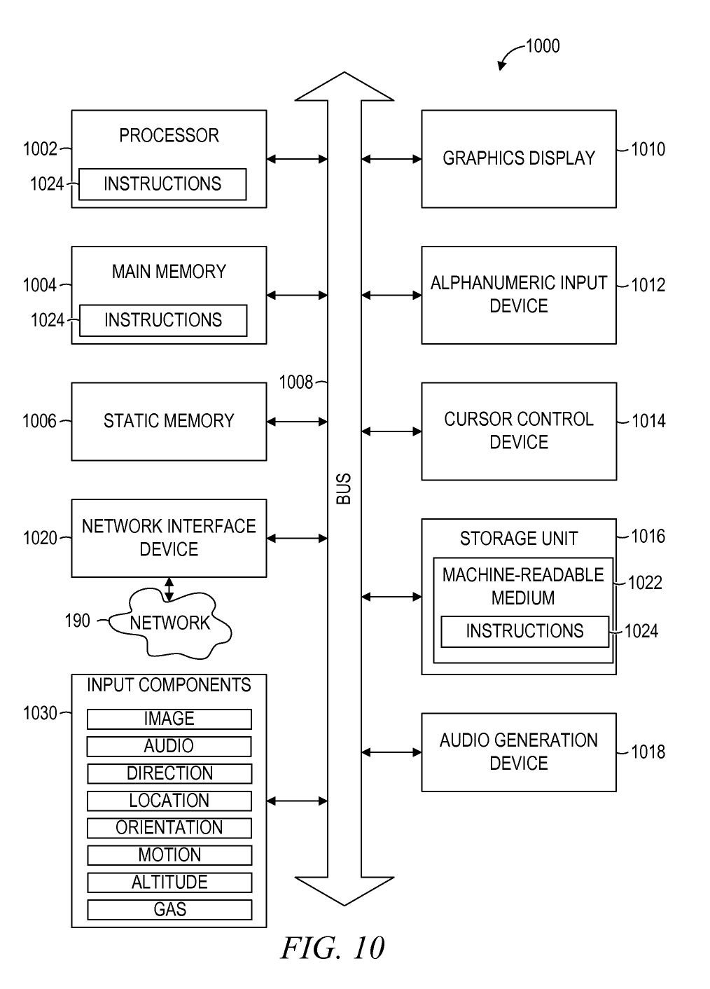

FIG. 1 is a network diagram illustrating a network environment 100 suitable (e.g., configured) for presenting active search results, according to some example embodiments. The network environment 100 includes a search machine 110, a database 115, and devices 130, 140, and 150, all communicatively coupled to each other via a network 190. The search machine 110 may form all or part of a network-based system 105 (e.g., a cloud-based server system configured to provide one or more services, such as search engine services, to the devices 130, 140, and 150). The search machine 110 and the devices 130, 140, and 150 may each be implemented in a computer system, in whole or in part, as described below with respect to FIG. 10. The search machine 110 may be configured to perform any one or more of the functions described above for a search machine, and the devices 130, 140, and 150 may each be configured to perform any one or more of the functions described above for a device (e.g., smartphone or computer).

Also shown in FIG. 1 are users 132 and 152. One or both of the users 132 and 152 may be a human user (e.g., a human being), a machine user (e.g., a computer configured by a software program to interact with the device 130, the device 140, the device 150, or any suitable combination thereof), or any suitable combination thereof (e.g., a human assisted by a machine or a machine supervised by a human). The user 132 is not part of the network environment 100, but is associated with (e.g., corresponds to) the devices 130 and 140 and may be a user of the device 130 and 140 (e.g., simultaneously or at different times separately). For example, the device 130 may be a desktop computer, a vehicle computer, a tablet computer, a navigational device, a portable media device, a smartphone, or a wearable device (e.g., a smart watch or smart glasses) belonging to the user 132. Similarly, the device 140 may be a desktop computer, a vehicle computer, a tablet computer, a navigational device, a portable media device, a smartphone, or a wearable device (e.g., a smart watch or smart glasses) belonging to the user 132. Likewise, the user 152 is not part of the network environment 100, but is associated with the device 150. As an example, the device 150 may be a desktop computer, a vehicle computer, a tablet computer, a navigational device, a portable media device, a smartphone, or a wearable device (e.g., a smart watch or smart glasses) belonging to the user 152.

Any of the machines, databases, or devices shown in FIG. 1 may be implemented in a special-purpose computer that has been modified (e.g., configured or programmed) by software (e.g., one or more software modules) to perform one or more of the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

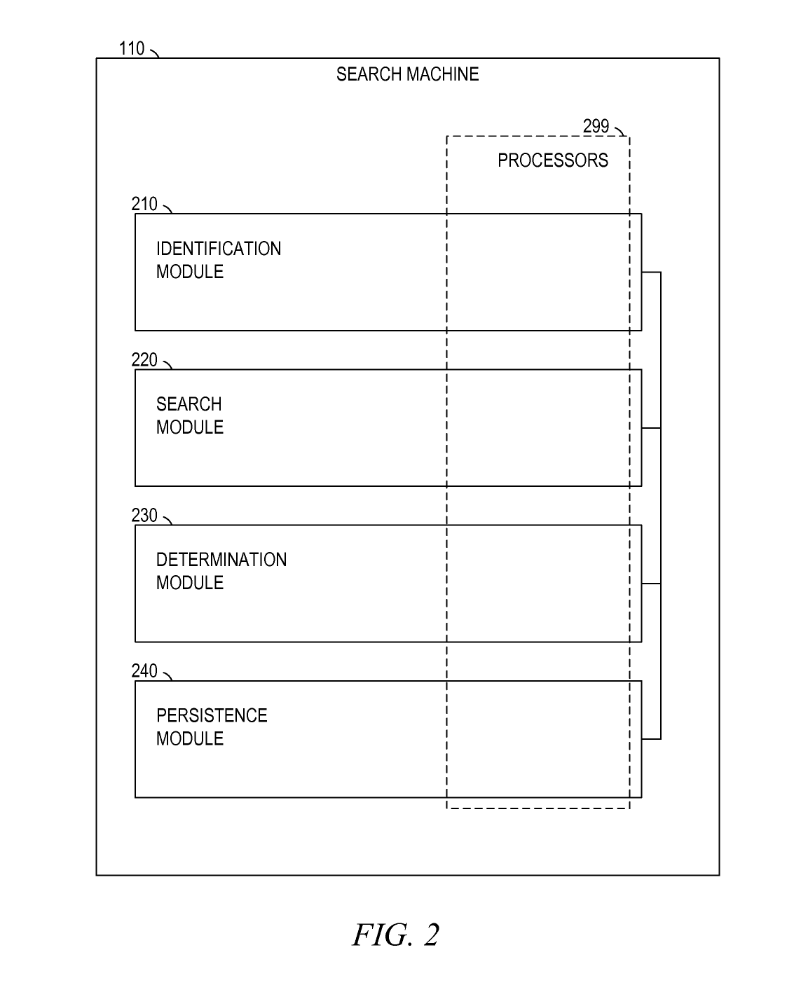

FIG. 2 is a block diagram illustrating components of the search machine 110 that configure the search machine 110 to present active search results, according to some example embodiments. The search machine 110 is shown as including an identification module 210, a search module 220, a determination module 230, and a persistence module 240, all configured to communicate with each other (e.g., via a bus, shared memory, or a switch). Any one or more of these modules may be implemented using one or more processors 299 and hence may include one or more of the processors 299 (e.g., by configuring such one or more processors to perform functions described for that module).

Any one or more of the modules described herein may be implemented using hardware alone (e.g., one or more processors 299 of a machine) or a combination of hardware and software. For example, any module described above in the search machine 110 may physically include an arrangement of one or more processors 299 (e.g., a subset of or among the one or more processors of the machine) configured to perform the operations described herein for that module. As another example, any module of the search machine 110 may include software, hardware, or both, that configure an arrangement of one or more processors 299 (e.g., among the one or more processors of the machine) to perform the operations described herein for that module. Accordingly, different modules of the search machine 110 may include and configure different arrangements of such processors 299 or a single arrangement of such processors 299 at different points in time. Moreover, any two or more modules of the search machine 110 may be combined into a single module, and the functions described herein for a single module may be subdivided among multiple modules. Furthermore, according to various example embodiments, modules described herein as being implemented within a single machine, database, or device may be distributed across multiple machines, databases, or devices.

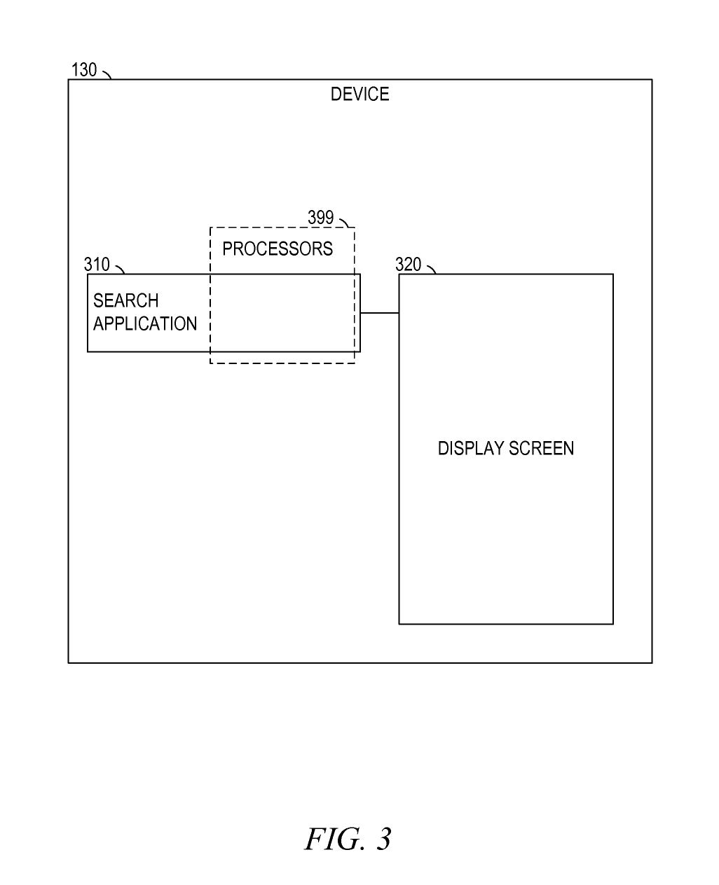

FIG. 3 is a block diagram illustrating components of the device 130 (e.g., a first device, such as a smartphone) that configure the device 130 for presenting search results, according to some example embodiments. The device 130 is shown as including a search application 310 (e.g., an application, applet, or mobile app configured for connecting one or more searches) and a display screen 320, which are configured to communicate with each other (e.g., via a bus, shared memory, or a switch). The search application 310 may be implemented using one or more processors 399 and hence may include one or more of the processors 399 (e.g., by configuring such one or more processors to perform the functions of the search application 310). The device 150 (e.g., a third device) may be configured similarly.

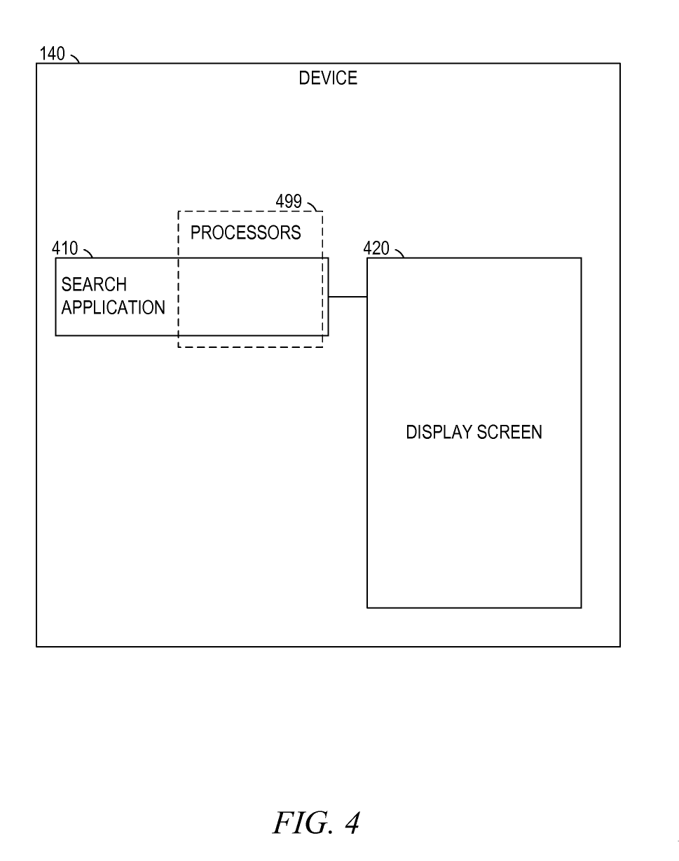

FIG. 4 is a block diagram illustrating components of the device 140 (e.g., a second device, such as a computer) that configure the device 140 for presenting active search results, according to some example embodiments. The device 140 is shown as including a search application 410 (e.g., an application, applet, or mobile app configured for connecting one or more searches) and a display screen 420, which are configured to communicate with each other (e.g., via a bus, shared memory, or a switch). The search application 410 may be implemented using one or more processors 499 and hence may include one or more of the processors 499 (e.g., by configuring such one or more processors to perform the functions of the search application 410).

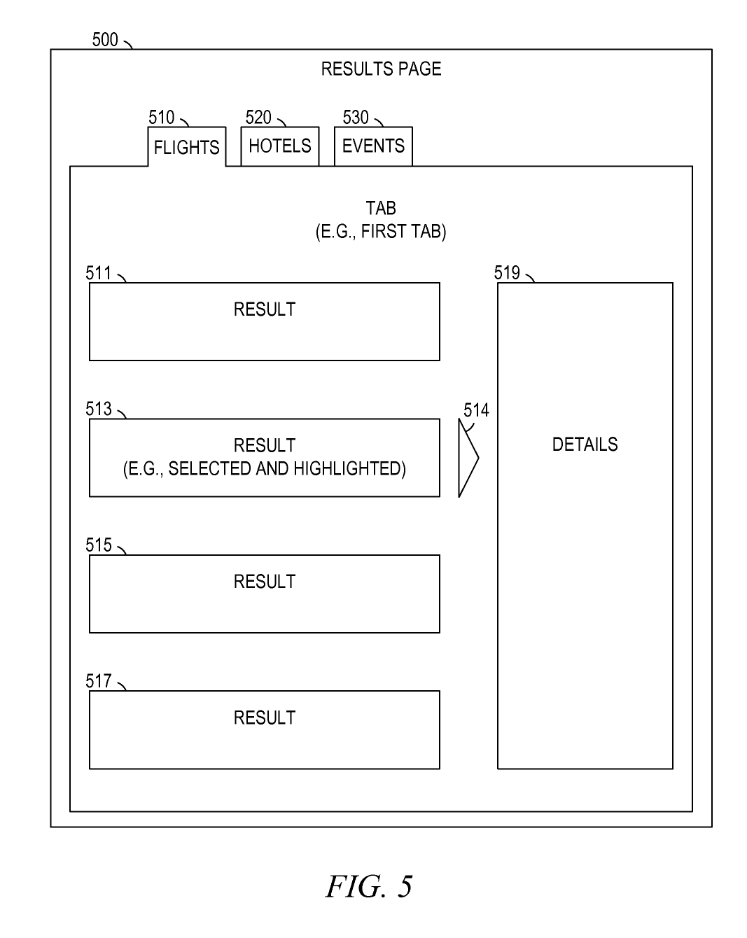

FIG. 5 is a diagram of a results page 500 having multiple tabs 510, 520, and 530 and showing results (e.g., a first set of search results) within the first tab 510 (e.g., labeled “flights” to indicate flight results), according to some example embodiments. The results page 500 may be configured as an interactive webpage or an interactive application screen (e.g., of the search application 310) that allows the user 132 (e.g., Bob) to display the contents of each tab by clicking or touching their labels (e.g., “flights,” “hotels,” or “events”). As noted above, additional types of searches (e.g., car rentals, cruises, vacation packages, and spa services) may be implemented in a similar manner, and search results from additional types of searches may be shown in additional tabs within the results page 500.

The first tab 510 (e.g., labeled “flights”) is shown as displaying results 511, 513, 515, and 517 (e.g., available airline flights). The first tab 510 may be configured as an interactive tab that allows the user 132 (e.g., Bob) to select (e.g., by a touch or a click) the result 513, for example. Selection of the result 513 (e.g., a specific airline flight) may cause a selection indicator 514 to appear and indicate that the result 513 has been selected (e.g., as indicated by proximity to the selection indicator 514, highlighting, other emphasis, or any suitable combination thereof). Moreover, selection of the result 513 may cause a details panel 519 to appear and provide supplemental, additional, or complementary information that references the selected result 513.

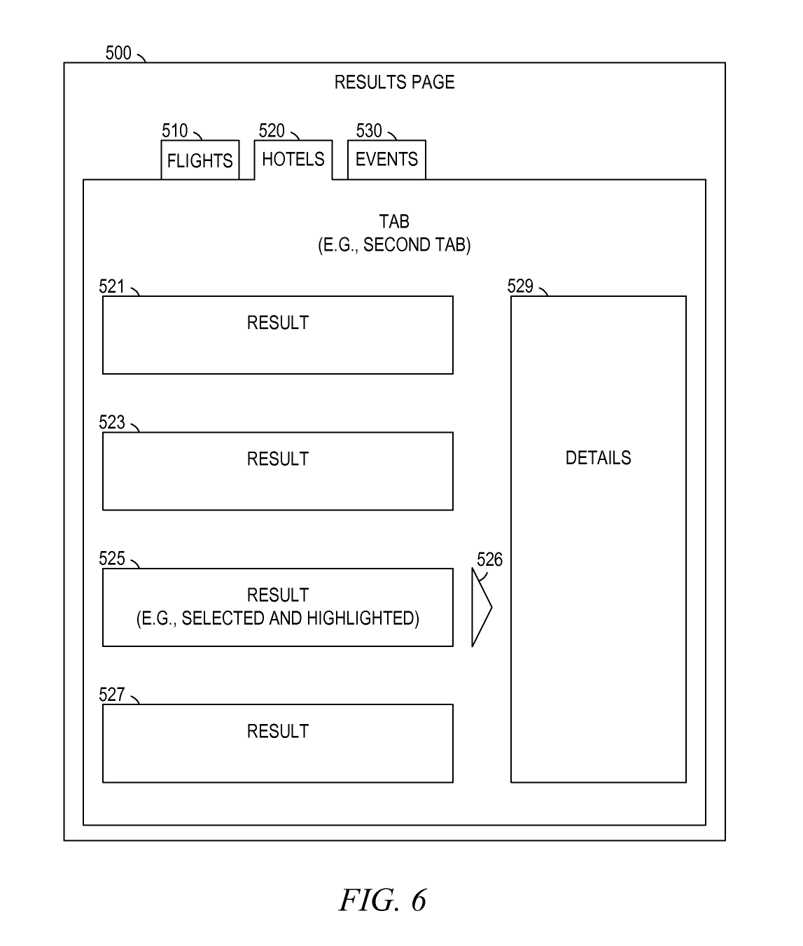

FIG. 6 is a diagram of the results page 500 showing additional results (e.g., a second set of active search results) within a second tab 520, according to some example embodiments. The second tab 520 (e.g., labeled “hotels” to indicate hotel results) is shown as displaying results 521, 523, 525, and 527 (e.g., available hotel stays). The second tab 520 may be configured as an interactive tab that allows the user 132 (e.g., Bob) to select (e.g., by a touch or a click) the result 525, for example. Selection of the result 525 (e.g., a specific hotel stay) may cause a selection indicator 526 to appear and indicate that the result 525 has been selected (e.g., as indicated by proximity to the selection indicator 526, highlighting, other emphasis, or any suitable combination thereof). Moreover, selection of the result 525 may cause a details panel 529 to appear and provide supplemental, additional, or complementary information that references the selected result 525.

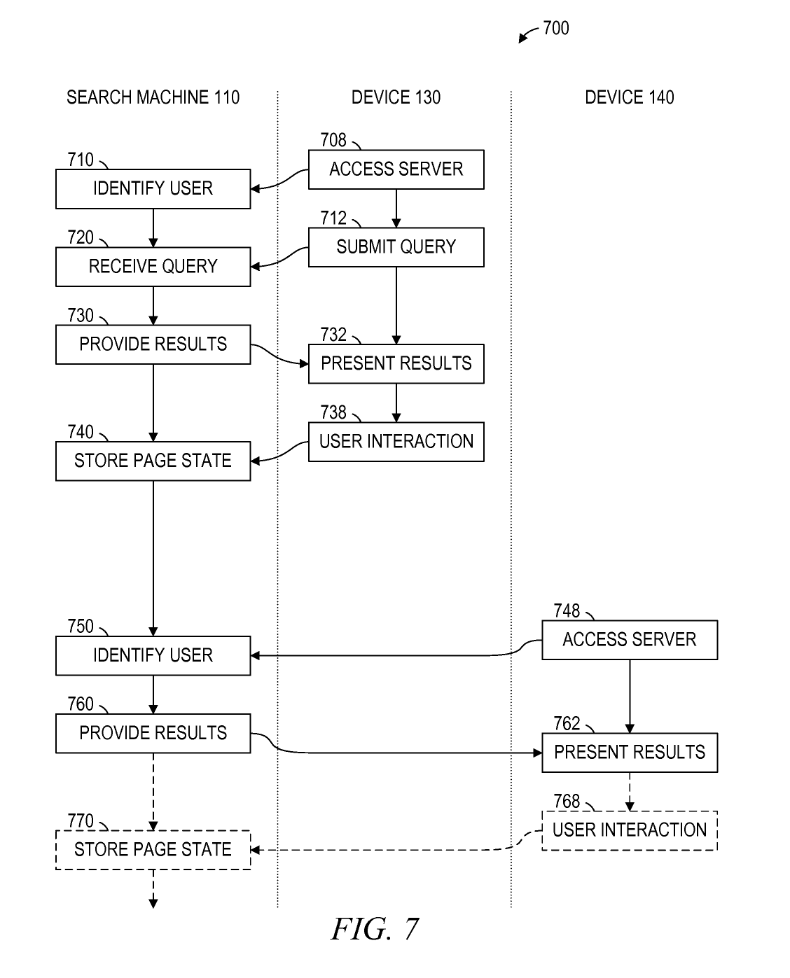

FIG. 7 is a flowchart illustrating data flows within the network environment 100, according to some example embodiments of a method 700 for presenting active search results. According to various example embodiments, the method 700 includes operations 708, 710, 712, 720, 730, 732, 738, 740, 748, 750, 760, and 762. Some example embodiments additionally include one or more of operations 768 and 770.

In operation 708, the device 130 (e.g., the first device of the user 132) accesses the network-based system 105 (e.g., by accessing the search machine 110). For example, the search application 310 may be launched on the device 130 (e.g., by the user 132) and, executing on the device 130, the search application 310 may cause the device 130 to initiate communication with the search machine 110.

In operation 710, the search machine 110 identifies the user 132 (e.g., Bob) that corresponds to the device 130. In operation 712, the device 130 submits a query (e.g., in the form of one or more search criteria) to the search machine 110. In corresponding operation 720, the search machine 110 receives the submitted query.

In operation 730, the search machine 110 provides results of the submitted query to the device 130. In operation 732, the device 130 (e.g., as configured by the search application 310) presents one or more of these provided results to the user 132 (e.g., within the results page 500, on the display screen 320). In operation 738, the user 132 performs one or more user interactions (e.g., makes a selection, applies a filter, applies a sort, applies a “like” indicator, marks a favorite, saves a search result, shares a search result with a friend, deletes search criteria, modifies search criteria, closes a tab of results, or any suitable combination thereof) with the presented search results (e.g., within the results page 500), and the device 130 (e.g., as configured by the search application 310) may communicate these interactions to the search machine 110. In corresponding operation 740, the search machine 110 generates and stores a page state (e.g., state of the results page 500) that indicates the content, selections, and layout of the presented search results (e.g., results page 500). According to various example embodiments, the search machine 110 may repeatedly perform any one or more of operations 720, 730, and 740 as the user 132 interacts with the search application 310, such that each time operation 740 is performed, the search machine 110 generates and stores a freshly updated version of the page state.

In operation 748, the device 140 (e.g., the second device of the same user 132) accesses the network-based system 105 (e.g., by accessing the search machine 110). Similar to operation 708, the search application 410 may be launched on the device 140 (e.g., by the user 132) and, executing on the device 140, the search application 410 may cause the device 140 to initiate communication with the search machine 110.

In operation 750, the search machine 110 identifies the returning user 132 (e.g., Bob) that corresponds to the device 140. Operation 750 may be performed similarly to operation 710.

In operation 760, the search machine 110 provides one or more of the results (e.g., results determined to be active results) from the previously submitted query to the device 140 (e.g., provides a subset of the previously provided results). In some example embodiments, the search machine 110 causes the device 140 (e.g., as configured by the search application 410) to present the user 132 with a default page (e.g., a new search page) with tabs (e.g., tabs 510, 520, or 530) that are hidden from view but preloaded with one or more the previously provided results (e.g., active search results). In other example embodiments, the search machine 110 causes the device 140 to present one or more preloaded tabs (e.g., tabs 510, 520, or 530) without showing a default page.

In operation 762, the device 140 (e.g., as configured by the search application 410) presents the provided results to the user 132 (e.g., within the results page 500, on the display screen 420). According to various example embodiments, the method 700 may continue with operations 768 and 770, which may be performed in a manner similar to operations 738 and 740.

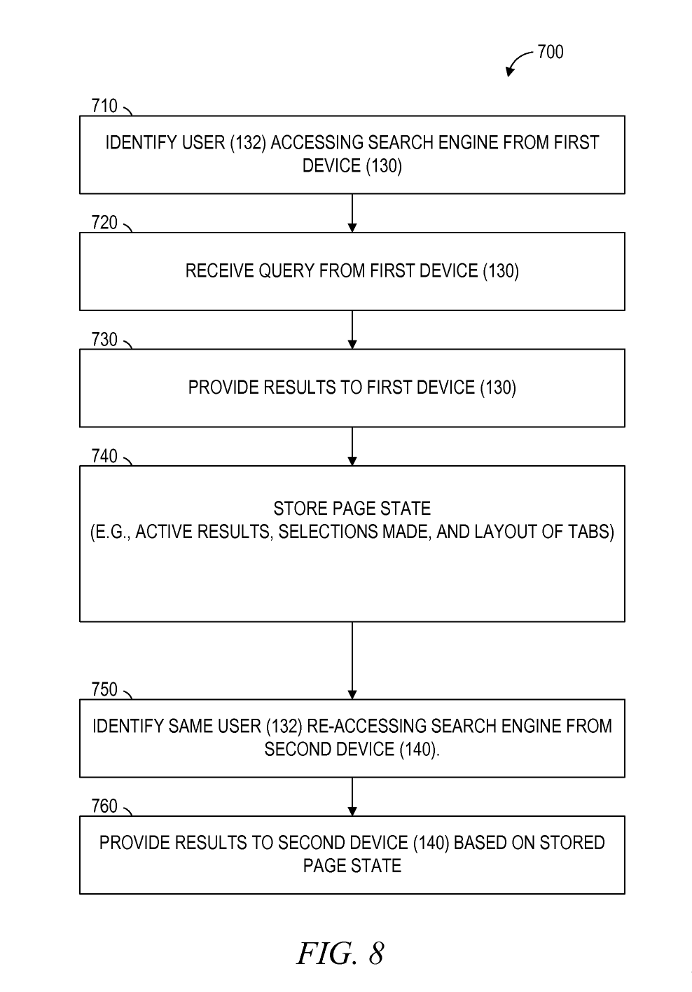

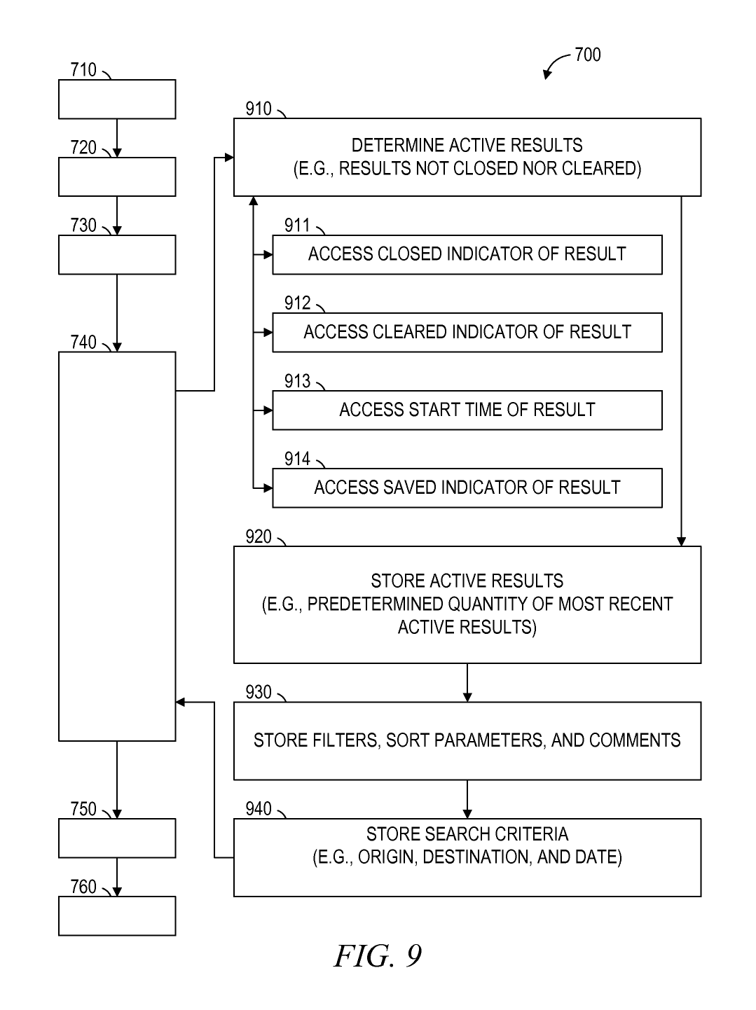

FIGS. 8 and 9 are flowcharts illustrating operations of the search machine 110 in performing the method 700 of presenting active search results, according to some example embodiments. As shown in FIG. 8, some example embodiments of the method 700 may be performed by the search machine 110, using modules described above with respect to FIG. 2. FIG. 8 shows the method 700 including one or more of operations 710, 720, 730, 740, 750, and 760, which are briefly described above with respect to FIG. 7.

As noted above, operation 710 involves identifying the user 132 (e.g., Bob). In some example embodiments, the identification module 210 of the search machine 110 performs operation 710 by accessing information stored on the device 130. For example, the identification module 210 may access login credentials of the user 132, a persistent cookie stored on the device 130 (e.g., from a previous communication session between the device 130 and the search machine 110), a network address of the device 130 (e.g., Internet protocol (IP) address), a hardware identifier of the device 130 (e.g., a media access control (MAC) address or an international mobile station equipment (IMEI) number), or any suitable combination thereof. The identification module 210 may compare the accessed information to the database 115, which may correlate the accessed information with the user 132, and hence identify the user 132.

Operation 720 may be performed by the search module 220 of the search machine 110. For example, the search module 220 may receive a query from the device 130 (e.g., the first device) as a submission of one or more search criteria (e.g., an origin, a destination, and a date for a flight search, or a destination and one or more dates for a hotel search).

Operation 730 may be performed by the search module 220. For example, the search module 220 may search one or more databases (e.g., database 115, with or without additional searching in third-party databases) for search results based on the query received in operation 720, and obtain the results that are provided to the device 130 (e.g., the first device) in operation 730.

Operation 740 may be performed by the persistence module 240 of the search machine 110. For example, the persistence module 240 may store the page state of the results page 500 within the database 115. As discussed below with respect to FIG. 9, the persistence module 240 may store the page state based on output of the determination module 230, which may configure the search machine 110 to determine one or more sets of active results (e.g., active search results).

Operation 750 may be performed by the identification module 210, and operation 750 may be performed with respect to the device 140 (e.g., the second device) in a manner similar to operation 710 with respect to the device 130 (e.g., the first device). For example, the identification module 210 may access login credentials of the user 132, a persistent cookie stored on the device 140 (e.g., from a previous communication session between the device 140 and the search machine 110), a network address of the device 140 (e.g., IP address), a hardware identifier of the device 140 (e.g., a MAC address or an IMEI number), or any suitable combination thereof. The identification module 210 may compare the accessed information to the database 115, which may correlate the accessed information with the user 132, and hence identify the user 132. In other words, in operation 750, the identification module 210 may detect that the same user 132 (e.g., Bob) identified in operation 710 is accessing the search machine 110 from the device 140.

Operation 760 may be performed by the search module 220, and operation 760 may be performed with respect to the device 140 (e.g., the second device) in a manner similar to operation 730 with respect to the device 130 (e.g., the first device) but with the additional influence of the page state stored by the persistence module 240 in operation 740. For example, the search module 220 may access the stored page state (e.g., from the database 115) and provide the device 140 (e.g., the second device) with a subset (e.g., a portion) of the results that previously were provided to the device 130 (e.g., the first device), based on the accessed page state (e.g., some or all of the accessed page state). As discussed below with respect to FIG. 9, the persistence module 240 may have determined this subset as the active results (e.g., active search results) prior to the page state being stored in operation 740.

As shown in FIG. 9, one or more of operations 910, 911, 912, 913, 914, 920, 930, and 940 may be performed as part (e.g., a precursor task, a subroutine, or portion) of operation 740, in which the persistence module 240 stores the page state of the results page 500 (e.g., in the database 115). Operation 910 may include one or more of operations 911-914 as part of operation 910.

In operation 910, the determination module 230 of the search machine 110 determines one or more sets of one or more active results (e.g., active search results) from the results that were previously provided to the device 130 (e.g., the first device) in operation 730. This may be performed based on results obtained from one or more of operations 911-914. In addition, according to various example embodiments, the determination module 230, in performing operation 910, may limit the active searches to a predetermined number of most recent active searches (e.g., previous ten active searches), determined on the basis of one or more results from operations 911-914.

In operation 911, the determination module 230 accesses a closed indicator of a result (e.g., one or more of results 511-517 or one or more of results 521-527). The closed indicator may be a descriptor, flag, tag, or other metadata that corresponds to a result (e.g., result 511) and that indicates whether the result has been explicitly closed or otherwise explicitly discarded by the user 132. The accessing of the closed indicator may be from the database 115. For example, if the user 132 views the results page 500 and proactively requests or commands that the tab containing the result (e.g., the first tab 510) or the entire results page 500 be closed (e.g., as part of the user interaction discussed above with respect to operation 738), the persistence module 240 may set the closed indicator to “yes” (e.g., within the database 115, as part of operation 740). Otherwise, if the tab and the results page 500 have not been closed, the closed indicator for the result may be set to “no,” which may be a default value for the closed indicator of that result. Accordingly, in performing operation 910, the determination module 230 may determine that the result is an active result (e.g., an active search result) based on the accessed closed indicator indicating that the result is not closed.

In operation 912, the determination module 230 accesses a cleared indicator of a result (e.g., one or more of results 511-517 or one or more results 521-527). The cleared indicator may be a descriptor, flag, tag, or other metadata that corresponds to a result (e.g., result 511) and indicates whether the result has been explicitly cleared or otherwise superseded by one or more newer results. The accessing of the cleared indicator may be from the database 115. For example, if the user 132 views the results page 500 and proactively requests or commands that the tab containing the result (e.g., the first tab 510) or the entire results page 500 be cleared of all search results, all search criteria, or both (e.g., as part of the user interaction discussed above with respect to operation 738), the persistence module 240 may set the cleared indicator to “yes” (e.g., within the database 115, as part of operation 740). Otherwise, if the tab and the results page 500 have not been cleared of search results, the cleared indicator for the result may be sent to “no,” which may be a default value for the cleared indicator of that result. Accordingly, in performing operation 910, the determination module 230 may determine that the result is an active result (e.g., an active search result) based on the accessed cleared indicator indicating that the result is not cleared.

In operation 913, the determination module 230 accesses a start time of a result (e.g., one or more of the results 511-517 or one or more of the results 521-527). The start time may be or include metadata that corresponds to a result (e.g., 511) that indicates a time at which a service or event referenced by the result is scheduled to start. For example, the result 511 may be a flight result that references an available airline flight with a departure time and date (e.g., 7 AM on Apr. 15, 2015), and that departure time and date may be the start time of the result 511. As another example, the result 511 may be a hotel result that references an available hotel reservation with a check-in deadline time and date (e.g., 10 PM on Apr. 15, 2015), and that check-in deadline time and date may be the start time of the result 511. Accordingly, in performing operation 910, the determination module 230 may determine that the result is an active result (e.g., an active search result) based on the start time of the result indicating that the result is not expired. As noted above, expired search results may be those that indicate a travel date in the past or scheduled to occur within an unreasonably short time (e.g., a flight that departs in 60 minutes from airport that is located over 60 minutes away by car, or a hotel reservation at a hotel located over 10 hours away by airplane or by car with a check-in deadline in 10 hours from a current time).

In operation 914, the determination module 230 accesses a saved indicator of a result (e.g., one or more of results 511-517 or one or more of results 521-527). The saved indicator may be a descriptor, flag, tag, or other metadata that corresponds to a result (e.g., result 511) and that indicates whether the result has been explicitly saved or otherwise marked for interest, discussion, or follow-up action later by the user 132. For example, the saved indicator may indicate that the result has been bookmarked as a favorite, indicated as being liked, added to a wish list, added to a shopping cart, marked with a star icon, shared with another user by email or other messaging service, or any suitable combination thereof. Accordingly, in performing operation 910, the determination module 230 may determine that the result is an active result (e.g., active search result) based on the saved indicator indicating that the result has been saved by the user 132.

In operation 920, the persistence module 240 of the search machine 110 stores the results determined to be active results (e.g., as determined by the determination module 230 in operation 910). In some example embodiments, the persistence module 240 may limit the number of active searches to a predetermined number of most recent active searches (e.g., previous ten active searches).

In operation 930, the persistence module 240 stores additional information that indicates, specifies, or defines the contents of the tabs 510, 520, and 530 of the results page 500, indicators of any selections made by the user (e.g., indicated by the selection indicators 514 and 526), and the layout (e.g., arrangement) of some or all tabs (e.g., tabs 510, 520, and 530) within the results page 500. For example, the persistence module 240 may store (e.g., as the page state of the results page 500) positions of the selection indicators 514 and 526 within the results page 500, as well as one or more filter parameters, sort parameters (e.g., ranking parameters), and comments applied to one or more results (e.g., results 513 and 517) during the user interaction discussed above with respect to operation 738. The stored information may form all or part of the page state of the results page 500.

In operation 940, the persistence module 240 stores one or more sets of search criteria used to generate the results presented in the results page 500. For example, the persistence module 240 may store (e.g., as part of the page state of the results page 500) an origin, a destination, and a date for a flight search that generated the results 511-517 in the first tab 510 (e.g., labeled “flights”), a destination and one or more dates for a hotel search that generated the results 521-527 in the second tab 520 (e.g., labeled “hotels”), a location and one or more dates for an event search that generated additional results in the third tab 530 (e.g., labeled “events”), or any suitable combination thereof.

According to various example embodiments, one or more of the methodologies described herein may facilitate presentation of active results, such as active search results. Moreover, one or more of the methodologies described herein may facilitate a resumption of online searching or shopping via a second device after the online searching or shopping was suspended, stopped, or interrupted on a first device. Hence, one or more the methodologies described herein may facilitate maintaining a user's sense of context, results, and continuity in online searching and shopping, despite initiating the searching or shopping on the first device and later continuing the searching or shopping on the second device.

When these effects are considered in aggregate, one or more of the methodologies described herein may obviate a need for certain efforts or resources that otherwise would be involved in preserving context, results, and continuity in online searching and shopping. Efforts expended by a user in returning to a previously initiated context and previously viewed results (e.g., alongside additional results presented as new suggestions or recommendations) may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 10 is a block diagram illustrating components of a machine 1000, according to some example embodiments, able to read instructions 1024 from a machine-readable medium 1022 (e.g., a non-transitory machine-readable medium, a machine-readable storage medium, a computer-readable storage medium, or any suitable combination thereof) and perform any one or more of the methodologies discussed herein, in whole or in part. Specifically, FIG. 10 shows the machine 1000 in the example form of a computer system (e.g., a computer) within which the instructions 1024 (e.g., software, a program, an application, an applet, an app, or other executable code) for causing the machine 1000 to perform any one or more of the methodologies discussed herein may be executed, in whole or in part.

In alternative embodiments, the machine 1000 operates as a standalone device or may be communicatively coupled (e.g., networked) to other machines. In a networked deployment, the machine 1000 may operate in the capacity of a server machine or a client machine in a server-client network environment, or as a peer machine in a distributed (e.g., peer-to-peer) network environment. The machine 1000 may be a server computer, a client computer, a PC, a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1024, sequentially or otherwise, that specify actions to be taken by that machine. Further, while only a single machine is illustrated, the term “machine” shall also be taken to include any collection of machines that individually or jointly execute the instructions 1024 to perform all or part of any one or more of the methodologies discussed herein.

The machine 1000 includes a processor 1002 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1004, and a static memory 1006, which are configured to communicate with each other via a bus 1008. The processor 1002 may contain solid-state digital microcircuits (e.g., electronic, optical, or both) that are configurable, temporarily or permanently, by some or all of the instructions 1024 such that the processor 1002 is configurable to perform any one or more of the methodologies described herein, in whole or in part. For example, a set of one or more microcircuits of the processor 1002 may be configurable to execute one or more modules (e.g., software modules) described herein. In some example embodiments, the processor 1002 is a multicore CPU (e.g., a dual-core CPU, a quad-core CPU, or a 128-core CPU) within which each of multiple cores is a separate processor that is able to perform any one or more of the methodologies discussed herein, in whole or in part. Although the beneficial effects described herein may be provided by the machine 1000 with at least the processor 1002, these same effects may be provided by a different kind of machine that contains no processors (e.g., a purely mechanical system, a purely hydraulic system, or a hybrid mechanical-hydraulic system), if such a processor-less machine is configured to perform one or more of the methodologies described herein.

The machine 1000 may further include a graphics display 1010 (e.g., a plasma display panel (PDP), a light emitting diode (LED) display, a liquid crystal display (LCD), a projector, a cathode ray tube (CRT), or any other display capable of displaying graphics or video). The machine 1000 may also include an alphanumeric input device 1012 (e.g., a keyboard or keypad), a cursor control device 1014 (e.g., a mouse, a touchpad, a trackball, a joystick, a motion sensor, an eye tracking device, or other pointing instrument), a storage unit 1016, an audio generation device 1018 (e.g., a sound card, an amplifier, a speaker, a headphone jack, or any suitable combination thereof), and a network interface device 1020.

The storage unit 1016 includes the machine-readable medium 1022 (e.g., a tangible and non-transitory machine-readable storage medium) on which are stored the instructions 1024 embodying any one or more of the methodologies or functions described herein. The instructions 1024 may also reside, completely or at least partially, within the main memory 1004, within the processor 1002 (e.g., within the processor's cache memory), or both, before or during execution thereof by the machine 1000. Accordingly, the main memory 1004 and the processor 1002 may be considered machine-readable media (e.g., tangible and non-transitory machine-readable media). The instructions 1024 may be transmitted or received over the network 190 via the network interface device 1020. For example, the network interface device 1020 may communicate the instructions 1024 using any one or more transfer protocols (e.g., hypertext transfer protocol (HTTP)).

In some example embodiments, the machine 1000 may be a portable computing device, such as a smart phone or tablet computer, and have one or more additional input components 1030 (e.g., sensors or gauges). Examples of such input components 1030 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1022 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1024 for execution by the machine 1000, such that the instructions 1024, when executed by one or more processors of the machine 1000 (e.g., processor 1002), cause the machine 1000 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible and non-transitory data repositories (e.g., data volumes) in the example form of a solid-state memory chip, an optical disc, a magnetic disc, or any suitable combination thereof. A “non-transitory” machine-readable medium, as used herein, specifically does not include propagating signals per se. In some example embodiments, the instructions 1024 for execution by the machine 1000 may be communicated by a carrier medium. Examples of such a carrier medium include a storage medium (e.g., a non-transitory machine-readable storage medium, such as a solid-state memory, being physically moved from one place to another place) and a transient medium (e.g., a propagating signal that communicates the instructions 1024).

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a CPU or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a CPU configured by software to become a special-purpose processor, the CPU may be configured as respectively different special-purpose processors (e.g., each included in a different hardware module) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. Accordingly, the operations described herein may be at least partially processor-implemented, since a processor is an example of hardware. For example, at least some operations of any method may be performed by one or more processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The performance of certain operations may be distributed among the one or more processors, whether residing only within a single machine or deployed across a number of machines. In some example embodiments, the one or more processors or hardware modules (e.g., processor-implemented modules) may be located in a single geographic location (e.g., within a home environment, an office environment, or a server farm). In other example embodiments, the one or more processors or hardware modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
by an identification module comprising one or more processors, identifying a user of a first device from which search criteria is received by a search engine;
by a search module comprising one or more processors, providing the first device with search results from the search engine in an interactive results page in response to the search criteria, the interactive results page enabling the user to select a search result among the provided search results and indicating that the search result has been selected;
by a determination module comprising one or more processors, determining that only a portion of the search results inclusive of the search result is to be indicated as active search results in a page state of the interactive results page;
by a persistence module comprising one or more processors, generating and storing the page state of the interactive results page, the page state indicating the portion of the search results as active search results and indicating that the search result has been selected;
by the identification module, identifying the user of the first device in response to the user accessing the search engine from a second device;
by the search module, providing the second device with the portion of the search results indicated by the page state as active search results and information from the page state indicating that the search result has been selected.

2. The method of claim 1, wherein:
the interactive results page is a first interactive results page; and
the provided information from the page state of the first interactive results page causes the second device to present the user with a second interactive results page that includes the portion of the search results and indicates that the search result has been selected.

3. The method of claim 1, wherein:
the interactive results page is a first interactive results page that includes multiple tabs that each contain a different subset of the search results;
the generated page state of the first interactive results page correlates each of the multiple tabs with the corresponding different subset of the search results; and
the provided information from the page state of the first interactive results page causes the second device to present the user with a second interactive results page that includes the same multiple tabs as the first interactive results page.

4. The method of claim 3, wherein:
the first interactive results page organizes the multiple tabs in a layout;
the generated page state of the first interactive results page specifies the layout in which the multiple tabs are organized; and
the provided information from the page state of the first interactive results page causes the second device to present the second interactive results page with the multiple tabs in the same layout as the first interactive results page.

5. The method of claim 1, wherein:
the interactive results page is a first interactive results page in which the search results have been ranked according to a ranking parameter;
the generated page state of the first interactive results page includes the ranking parameter according to which the search results have been ranked; and
the provided information from the page state of the first interactive results page causes the second device to present a second interactive results page that ranks the portion of the search results according to the same ranking parameter as the first interactive results page.

6. The method of claim 1, wherein:
the interactive results page is a first interactive results page in which the search results have been filtered according to a filter criterion;
the generated page state of the first interactive results page includes the filter criterion according to which the search results have been filtered; and
the provided information from the page state of the first interactive results page causes the second device to present a second interactive results page that filters the portion of the search results according to the same filter criterion as the first interactive results page.

7. The method of claim 1, wherein:
the interactive results page is a first interactive results page that enables the user to apply a comment to a further search result among the search results;
the generated page state of the first interactive results page includes the comment applied by the user to the further search result; and
the provided information from the page state of the first interactive results page causes the second device to present a second interactive results page that presents the comment with the further search result among the portion of the search results.

8. The method of claim 1, wherein:
the determining that only the portion of the search results is to be indicated as active search results includes:
accessing an indicator that indicates the user closed a tab in which a further search result among the search results is presented by the interactive results page; and
omitting the further search result from the portion of the search results based on the indicator that indicates the user closed the tab.

9. The method of claim 1, wherein:
the search results include first search results obtained based on first search criteria and second search results obtained based on second search criteria;
the interactive results page is a first interactive results page that presents the first search results in a first tab and presents the second search results in a second tab; and
the determining that only the portion of the search results is to be indicated as active search results includes:
accessing an indicator that indicates the user deleted the second search criteria; and
omitting the second search results from the portion of the search results based on the indicator that indicates the user deleted the second search criteria.

10. The method of claim 1, wherein:
the search results include first search results obtained based on first search criteria and second search results obtained based on second search criteria;
the interactive results page is a first interactive results page that presents the first search results in a first tab and presents the second search results in a second tab; and
the determining that only the portion of the search results is to be indicated as active search results includes:
accessing an indicator that indicates the user modified the second search criteria; and
omitting the second search results from the portion of the search results based on the indicator that indicates the user modified the second search criteria.

11. The method of claim 1, wherein:
the determining that only the portion of the search results is to be indicated as active search results includes:
accessing a start time of a further search result among the search results; and
omitting the further search result from the portion of the search results based on the start time of the further search result being in the past.

12. The method of claim 1, wherein:
the determining that only the portion of the search results is to be indicated as active search results includes:
accessing a start time of a further search result among the search results; and
omitting the further search result from the portion of the search results based on the start time of the further search result being in within a minimum threshold duration from a present time.

13. The method of claim 12, wherein:
the determining that only the portion of the search results is to be indicated as active search results includes accessing a location of the further search result; and
the omitting of the further search result is based on the location of the further search result in comparison to start time of the further search result.

14. The method of claim 1, wherein:
the determining that only the portion of the search results is to be indicated as active search results includes:
accessing an indicator that indicates the user saved a further search result among the search results; and
including the further search result in the portion of the search results based on the indicator that indicates the user saved the further search result.

15. The method of claim 1, wherein:
the determining that only the portion of the search results is to be indicated as active search results includes limiting the portion of the search results based on a maximum threshold quantity of active search results.

16. The method of claim 1, wherein:
the generated page state of the first interactive results page includes the search criteria; and the method further comprises:
after the storing of the page state that includes the search criteria, determining that the selected search result is unavailable;
obtaining further search results from the search engine based on the search criteria included in the stored page state; and
replacing the unavailable search result in the portion of the search results with a further search result among the further search results obtained from the search engine.

17. A non-transitory machine-readable storage medium comprising instructions that, when executed by one or more processors of a machine, cause the machine to perform operations comprising:
by an identification module comprising one or more of the processors, identifying a user of a first device from which search criteria is received by a search engine;
by a search module comprising one or more of the processors, providing the first device with search results from the search engine in an interactive results page in response to the search criteria, the interactive results page enabling the user to select a search result among the provided search results and indicating that the search result has been selected;
by a determination module comprising one or more of the processors, determining that only a portion of the search results inclusive of the search result is to be indicated as active search results in a page state of the interactive results page;
by a persistence module comprising one or more of the processors, generating and storing the page state of the interactive results page, the page state indicating the portion of the search results as active search results and indicating that the search result has been selected;
by the identification module, identifying the user of the first device in response to the user accessing the search engine from a second device;
by the search module, providing the second device with the portion of the search results indicated by the page state as active search results and information from the page state indicating that the search result has been selected.

18. The non-transitory machine-readable storage medium of claim 17, wherein:
the interactive results page is a first interactive results page that includes multiple tabs that each contain a different subset of the search results;
the generated page state of the first interactive results page correlates each of the multiple tabs with the corresponding different subset of the search results; and
the provided information from the page state of the first interactive results page causes the second device to present the user with a second interactive results page that includes the same multiple tabs as the first interactive results page.

19. A system comprising:
an identification module comprising one or more processors and configured to identify a user of a first device from which search criteria is received by a search engine;
a search module comprising one or more processors and configured to provide the first device with search results from the search engine in an interactive results page in response to the search criteria, the interactive results page enabling the user to select a search result among the provided search results and indicating that the search result has been selected;
a determination module comprising one or more processors and configured to determine that only a portion of the search results inclusive of the search result is to be indicated as active search results in a page state of the interactive results page;
a persistence module comprising one or more processors and configured to generate and store the page state of the interactive results page, the page state indicating the portion of the search results as active search results and indicating that the search result has been selected;
the identification module being further configured to identify the user of the first device in response to the user accessing the search engine from a second device;
the search module being further configured to provide the second device with the portion of the search results indicated by the page state as active search results and information from the page state indicating that the search result has been selected.

20. The system of claim 19, wherein:
the determination module is configured to determine that only the portion of the search results is to be indicated as active search results by performing operations comprising:
accessing an indicator that indicates the user closed a tab in which a further search result among the search results is presented by the interactive results page; and
omitting the further search result from the portion of the search results based on the indicator that indicates the user closed the tab.
